(19) United States
(12) Patent Application Publication
(10) Pub. No.: US 2023/0079785 A1
(43) Pub. Date: Mar. 16, 2023

(54) VIDEO CLIPPING METHOD AND APPARATUS, COMPUTER DEVICE, AND STORAGE MEDIUM

(71) Applicant: Tencent Technology (Shenzhen) Company Limited, Shenzhen (CN)

(72) Inventor: Xin XI, Shenzhen (CN)

(73) Assignee: Tencent Technology (Shenzhen) Company Limited, Shenzhen (CN)

(21) Appl. No.: 17/987,377

(22) Filed: Nov. 15, 2022

Related U.S. Application Data
(63) Continuation of application No. PCT/CN2022/079642, filed on Mar. 8, 2022.

(30) Foreign Application Priority Data
Mar. 25, 2021 (CN) 202110321822.X

(51) Int. Cl. G11B 27/031; G11B 27/34

(52) U.S. Cl. CPC G11B 27/031; G11B 27/34

(57) ABSTRACT

A video clipping method is provided. In the method, a game video and game event data corresponding to the game video are obtained in response to receiving a video clipping request. Clipping reference information corresponding to one or more target game events in the game video is determined according to the game event data. An initial clipped video is generated. The initial clipped video includes at least one video clip from the game video based on the clipping reference information. A target clipped video is generated based on the initial clipped video and a special effect type that is determined to correspond to each of at least one target game event of the one or more target game events.

### RELATED APPLICATIONS

The present application is a continuation of International Application No. PCT/CN2022/079642, entitled “VIDEO EDITING METHOD AND APPARATUS, AND COMPUTER DEVICE AND STORAGE MEDIUM” and filed on Mar. 8, 2022, which claims priority to Chinese Patent Application No. 202110321822.X, entitled “VIDEO CLIPPING METHOD AND APPARATUS, COMPUTER DEVICE, AND STORAGE MEDIUM” and filed on Mar. 25, 2021. The entire disclosures of the prior applications are hereby incorporated by reference in their entirety.

### FIELD OF THE TECHNOLOGY

This application relates to the field of computer technologies, including to video clipping.

### BACKGROUND OF THE DISCLOSURE

With the development of computer technologies and game technologies, more and more game videos can be shared on various platforms for users to watch. Before sharing the game video, an original game video usually needs to be clipped to obtain a game video required by the user. At present, most of the original game videos are clipped manually, which is quite troublesome, time-consuming, labor-intensive, inefficient, and prone to errors during clipping.

### SUMMARY

Embodiments of this disclosure provide a video clipping method and apparatus, a computer device, and a non-transitory computer-readable storage medium, which can analyze game data of a game match and realize an accurate judgment of highlight moments, and can also perform special effect processing on a clipped game video to automatically generate a game highlight video about a game player, to improve the efficiency of generating a game clipped video.

According to an aspect, a video clipping method is provided. The method may be performed by a server in an example. In the method, a game video and game event data corresponding to the game video are obtained in response to receiving a video clipping request. Clipping reference information corresponding to one or more target game events in the game video is determined according to the game event data. An initial clipped video is generated. The initial clipped video includes at least one video clip from the game video based on the clipping reference information. A target clipped video is generated based on the initial clipped video and a special effect type that is determined to correspond to each of at least one target game event of the one or more target game events.

According to an aspect, a video clipping method is provided. The method may be performed by a client in an example. In the method, a video clipping request is sent to a server in response to a user operation. A target clipped video is obtained. The target clipped video is generated based on an initial clipped video and a special effect type that is determined to correspond to each of at least one target game event in a game video. The initial clipped video includes a video clip of each of the at least one target game event from the game video. The target clipped video is played back in response to a playback operation.

According to an aspect, an embodiment of this disclosure provides a video clipping apparatus, including processing circuitry. The processing circuitry is configured to obtain a game video and game event data corresponding to the game video, in response to receiving a video clipping request. The processing circuitry is configured to determine clipping reference information corresponding to one or more target game events in the game video according to the game event data. The processing circuitry is configured to generate an initial clipped video. The initial clipped video includes at least one video clip from the game video based on the clipping reference information. Further, the processing circuitry is configured to generate a target clipped video based on the initial clipped video and a special effect type that is determined to correspond to each of at least one target game event of the one or more target game events.

According to an aspect, an embodiment of this disclosure provides a video clipping apparatus, including processing circuitry. The processing circuitry is configured to send a video clipping request to a server, in response to a user operation. The processing circuitry is configured to obtain a target clipped video. The target clipped video is generated based on an initial clipped video and a special effect type that is determined to correspond to each of at least one target game event in a game video. The initial clipped video includes a video clip of each of the at least one target game event from the game video. Further, the processing circuitry is configured to play back the target clipped video in response to a playback operation.

According to an aspect, an embodiment of this disclosure provides a computer device, including a processor, a memory and a network interface, the processor, the memory and the network interface being interconnected, the memory being configured to store a computer program, the computer program including program instructions, and the processor being configured to call the program instructions to perform any of the methods in the foregoing various embodiments.

According to an aspect, an embodiment of this disclosure provides a non-transitory computer-readable storage medium, storing instructions which when executed by a processor cause the processor to perform any of the methods in the various embodiments.

According to an aspect, an embodiment of this disclosure provides a computer program product or a computer program, the computer program product or the computer program including computer instructions, the computer instructions being stored in a computer-readable storage medium. A processor of a computer device reads the computer instructions from the computer-readable storage medium. The processor executes the computer instructions, so that the computer device performs any of the methods in the foregoing various embodiments.

In an embodiment of this disclosure, a server may respond to a video clipping request transmitted by a client to obtain a to-be-processed game video and game event data corresponding to the to-be-processed game video. Then the server determines clipping reference information corresponding to one or more target game events according to the game event data, and performs video clipping processing on the to-be-processed game video according to the clipping reference information to obtain an initial clipped video. Further, the server may determine a special effect type corresponding to each of the target game events, and perform special effect processing on the initial clipped video according to the special effect type corresponding to each of the target game events to obtain a target clipped video. By implementing the foregoing method, game data of a game match can be analyzed and an accurate judgment of highlight moments can be realized, and special effect processing can also be performed on a clipped game video to automatically generate a game highlight video about a game player, to improve the efficiency of generating the game clipped video.

### BRIEF DESCRIPTION OF THE DRAWINGS

FIG. 1 is a schematic architectural diagram of a video clipping system according to an embodiment of this disclosure.

FIG. 2 is a schematic flowchart of a video clipping method according to an embodiment of this disclosure.

FIG. 3 is a schematic flowchart of a video clipping method according to an embodiment of this disclosure.

FIG. 4 is a schematic flowchart of a video clipping method according to an embodiment of this disclosure.

FIG. 5 is a schematic flowchart of a video clipping method according to an embodiment of this disclosure.

FIG. 6 is a schematic flowchart of a video clipping method according to an embodiment of this disclosure.

FIG. 7a is a schematic diagram of a game settlement interface according to an embodiment of this disclosure.

FIG. 7b is a schematic diagram of a game video viewing interface according to an embodiment of this disclosure.

FIG. 7c is a schematic diagram of a game video central interface according to an embodiment of this disclosure.

FIG. 7d is a schematic diagram of a clipped video playback interface according to an embodiment of this disclosure.

FIG. 7e is a schematic diagram of a plurality of playback pictures in a clipped video playback interface according to an embodiment of this disclosure.

FIG. 8a is a schematic diagram of a saving target clipped video interface according to an embodiment of this disclosure.

FIG. 8b is a schematic diagram of a prompting to watch clipped video interface according to an embodiment of this disclosure.

FIG. 8c to FIG. 8e are schematic diagrams of a video editing interface according to an embodiment of this disclosure.

FIG. 9 is a schematic structural diagram of a video clipping apparatus according to an embodiment of this disclosure.

FIG. 10 is a schematic structural diagram of a video clipping apparatus according to an embodiment of this disclosure.

FIG. 11 is a schematic structural diagram of a computer device according to an embodiment of this disclosure.

### DESCRIPTION OF EMBODIMENTS

The following describes technical solutions of exemplary embodiments of this disclosure with reference to the accompanying drawings. The described embodiments are some rather than all of the embodiments of this disclosure. Other embodiments are within the scope of this disclosure.

Currently, a clipping of game highlight clips is generally realized based on highlight recognition based on local screen recording and data understanding, or based on local screen recording and image understanding. The method of highlight recognition based on local screen recording and data understanding needs to open up data flow of a game match with a game team. Taking a game as an example, a series of highlight performance in the game need to be pre-defined, such as “three consecutive eliminations”, “dive into tower and defeat”, and the like, and the data flow of the game match needs to be obtained, including fields such as “cast a skill”, “produce a defeat”, “a defeated hero ID”, “skill control number” and the like. Then according to a pre-defined highlight performance, the highlight performance is identified and judged for a plurality of fields, and a start time and an end time of the highlight performance in the game are obtained. In addition, a screen recording capability of a terminal needs to be called in a software development kit of the game to record the video of the highlight clips to obtain several video files of the highlight clips, and then return the video files to a game client for presentation to a user. The highlight recognition method based on local screen recording and image understanding needs to obtain a video playback file of the game match based on a built-in local screen recording capability or live stream of the game. Image material recognition is performed according to a series of interactive experiences (such as a streaming water broadcast, an operation control, and the like) in the process of the game match (in a special scenario, video black borders need to be cropped first) to realize a judgment of highlight performance. It is necessary to deduce the start time and end time around the highlight performance, so as to complete the clipping of highlight clips on the video file, and return the video file containing the highlight clips to the game client for presentation to the user.

It can be seen from the foregoing description that the clipping method for the foregoing game highlight clips may have the following problems: First, the video source file is based on local screen recording. The local screen recording is a negative behavior for ordinary players of the game. One reason is that due to the limitation of a terminal model, some players cannot turn on the local screen recording in their terminals; the other reason is that due to the performance of the terminal, executing the game process with the screen recording function turned on may cause the game to freeze and the terminal to become hot. Second, the foregoing clipping method can support screen capture of highlight clips, but compared with highly popular game videos on the Internet (for example, adding a plot, a special effect, copywriting and the like to an original video), the user has a poor perception. Moreover, after obtaining the captured screen recording video, the player may further need to perform a more complicated second-generation editing operation to obtain a more exquisite highlight video. Third, the method relies on a period that the original screen recording file is stored in the terminal. Considering a terminal memory, it is generally possible to save an end of the game, but may not support the generation of highlight videos of a historical game match.

For the foregoing problems, the embodiments of this disclosure provide a video clipping method. The server may respond to a video clipping request transmitted by a client to obtain a to-be-processed game video and game event data corresponding to the to-be-processed game video. Then the server determines clipping reference information corresponding to one or more target game events according to the game event data, and performs video clipping processing on the to-be-processed game video according to the clipping reference information to obtain an initial clipped video. Further, the server may determine a special effect type corresponding to each of the target game events, and perform special effect processing on the initial clipped video according to the special effect type corresponding to each of the target game events to obtain a target clipped video. By implementing the foregoing method, game data of a game match can be analyzed and an accurate judgment of highlight moments can be realized, and special effect processing can also be performed on a clipped game video to automatically generate a game highlight video about a game player, to improve the efficiency of generating the game clipped video.

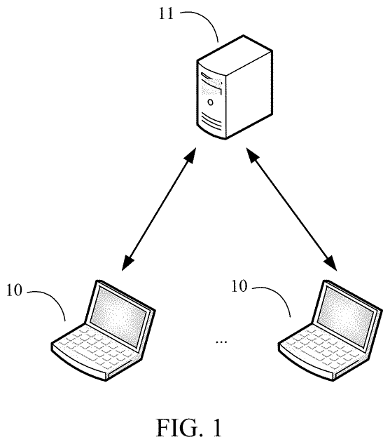

FIG. 1 is a schematic architectural diagram of a video clipping system according to an embodiment of this disclosure. This disclosure relates to a client 10 and a server 11.

Taking the client 10 as an example, the client 10 can send a video clipping request on a game settlement interface, and transmit the video clipping request to the server 11. The server 11, in response to the video clipping request transmitted by the client, obtains a to-be-processed game video and game event data corresponding to the to-be-processed game video, and determines clipping reference information corresponding to one or more target game events according to the game event data. The server 11 performs video clipping processing on the to-be-processed game video according to the clipping reference information to obtain an initial clipped video. The server 11 determines a special effect type corresponding to each of the target game events and performs special effect processing on the initial clipped video according to the special effect type corresponding to each of the target game events to obtain a target clipped video.

Subsequently, the server 11 transmits the determined target clipped video to the client 10, so that the target clipped video is played on a clipped video playback interface of the client.

The server 11 shown in FIG. 1 may be a cloud server for providing basic cloud computing services such as a cloud service, a cloud database, cloud computing, a cloud function, cloud storage, a network service, cloud communication, a middleware service, a domain name service, a security service, a CDN, and a big data and artificial intelligence platform.

The client 10 may be a game-type client run on a terminal. The terminal may be a smart device such as a mobile phone, a tablet computer, a notebook computer, a palmtop computer, a mobile Internet device (MID). The client 10 and the server 11 may be directly or indirectly connected in a wired or wireless communication manner. This is not limited in this disclosure.

Exemplary implementation details for technical solutions of embodiments of this disclosure are described below in further detail.

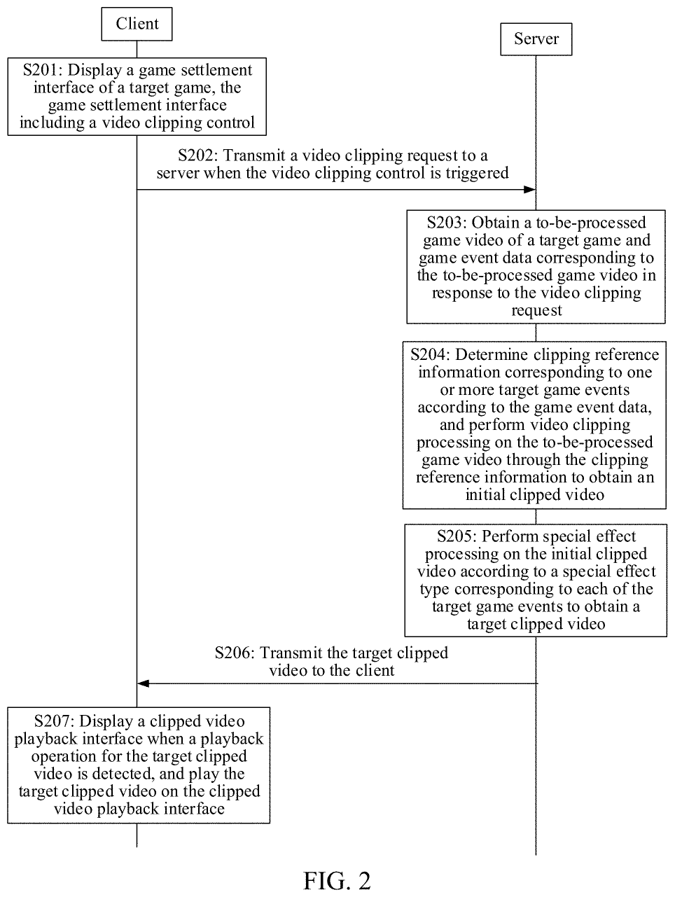

FIG. 2 is a schematic flowchart of a video clipping method according to an embodiment of this disclosure. The video clipping method includes a client (such as the client in the embodiment corresponding to FIG. 1) and a server (such as the server in the embodiment corresponding to FIG. 1). This embodiment mainly describes an interaction process between the client and the server, and the video clipping method includes the following steps:

In step S201, a client displays a game settlement interface of a target game, the game settlement interface including a video clipping control.

In step S202, the client transmits a video clipping request to a server when the video clipping control is triggered.

In S201 and S202, the client can display the game settlement interface. The game settlement interface may include the video clipping control, so that when a user clicks the video clipping control, the client is triggered to generate the video clipping request. Then when the client detects that the video clipping control is clicked, the client can be triggered to generate the video clipping request, and when the video clipping request is triggered, the video clipping request can be transmitted to the server. The foregoing client may be a game-type client. For example, the game-type client may be an A client, a B client and the like. This is not limited in this disclosure.

In step S203, the server, in response to the video clipping request transmitted by the client, obtains a to-be-processed game video of a target game and game event data corresponding to the to-be-processed game video.

In an implementation, the server can receive the video clipping request transmitted by the client, and when the server receives the video clipping request transmitted by the client, a to-be-processed game video for the video clipping request can be obtained. The to-be-processed game video may be a game match video that a user ends at any time, and the any time includes a current time and a historical time. That is, the to-be-processed game video may be a game match video that the user ends at the current moment, or a game match video that the user ends at the historical moment. In addition, the to-be-processed game video may be game content of a target game corresponding to the game settlement interface. When obtaining the to-be-processed game video, game event data corresponding to the to-be-processed game video may also be obtained, so as to subsequently perform clipping processing and other processing on the to-be-processed game video according to the game event data, to obtain a target clipped video required by the user. The game event data may be behavior data in the game when the user executes the game. For example, the game event data may include data corresponding to a game skill released by the user during the execution of the game, data corresponding to an opponent eliminated by the user, data corresponding to game equipment purchased by the user, character coordinates corresponding to a game character corresponding to the user at various times, and the like. In addition to the behavior data of the user, the game event data may also include time information corresponding to each behavior data. For example, for the game skill released by the user when he executes the game, a specific time when the user releases the game skill can also be recorded. In another example, for the opponent eliminated by the user during the execution of the game, a specific time when the opponent is eliminated may also be recorded. The game event data may also include other data generated during the game process, which is not limited in this disclosure.

In step S204, the server determines clipping reference information corresponding to one or more target game events according to the game event data, and performs video clipping processing on the to-be-processed game video through the clipping reference information to obtain an initial clipped video.

In an implementation, the server can determine, according to the obtained game event data, clipping reference information respectively corresponding to one or more target game events required by clipping the to-be-processed game video. The clipping reference information may include clipping time information.

In an implementation, the foregoing target game event may be a game highlight event generated during an execution of a game, that is, a highlight moment experienced by the user when the game is executed. For example, when the user executes the A game through the A client, the target game event may be defeat, skill control and the like in the A game. In another example, when the user executes the B game through the B client, the target game event may be defeat and elimination, extreme rescue and the like in the B game.

In an implementation, after the server determines the clipping reference information, the server can perform clipping processing on the to-be-processed game video according to the clipping reference information to obtain an initial clipped video. In a specific implementation, the clipping reference information may be clipping time information, and the clipping time information may be a clipping start time and a clipping end time corresponding to each of the target game events. Then the clipping processing can be performed on the to-be-processed game video according to the clipping start time and clipping end time of each of the target game events to obtain a game video clip corresponding to each of the target game events. After the game video clip corresponding to each of the target game events is determined, an initial clipped video can be obtained according to the game video clip corresponding to each of the target game events. Specifically, splicing processing may be performed on each game video clip, and the spliced game video is the initial clipped video.

In an implementation, when performing the splicing processing on each game video clip, the splicing processing on each game video clip may be performed according to a splicing priority of each game video clip. In an example, the splicing priority of each game video clip may be determined according to time corresponding to each game video clip, or may be determined according to a target game event corresponding to each game video clip.

In an example, a specific implementation of determining the splicing priority according to the time corresponding to each game video clip may be: performing the splicing processing on each game video clip according to a time sequence of each game video clip. Specifically, time information corresponding to each game video clip may be obtained. The time information may be a start time, an end time, an intermediate time, or the like for the game video clip. After the time information corresponding to each game video clip is determined, the game video clips may be spliced according to the time sequence corresponding to each game video clip. For example, taking the time information as a start time as an example, if there are three game video clips (clip 1, clip 2, and clip 3), and corresponding start times of the three game video clips are 09:23:15, 09:23:12 and 09:23:19 respectively, then the splicing sequence of the three game video clips is clip 2, clip 1, clip 3 in sequence, that is, the initial clipped video is formed by clip 2, clip 1, and clip 3.

In an example, a specific implementation of determining the splicing priority according to the target game event corresponding to each game video clip may be: performing the splicing processing on each game video clip according to the importance of the target game event corresponding to each game video clip. The degree of importance can be reflected according to weight. The larger the weight, the higher the degree of importance. Correspondingly, the smaller the weight, the lower the degree of importance. Specifically, a weight of the target game event corresponding to each game video clip may be first obtained. The weight corresponding to each of the target game events may be preset. For example, the target game event may be “three consecutive eliminations”, “dive into tower and defeat”, “skill control” and the like. A weight corresponding to “three consecutive eliminations” may be 0.7, a weight corresponding to “dive into tower and defeat” may be 0.5, and a weight corresponding to “skill control and the like” may be 0.4. After the weight corresponding to each game video clip is determined, the game video clips may be spliced according to the size of the weight corresponding to each game video clip. For example, if target game events corresponding to three game video clips (clip 1, clip 2, and clip 3) are “three consecutive eliminations”, “dive into tower and defeat”, “skill control and the like” respectively, and the weights corresponding to the three target game events are 0.7, 0.5, and 0.4 respectively, then the splicing sequence of the three game video clips is clip 1, clip 2, clip 3 in sequence, that is, the initial clipped video is formed by clip 1, clip 2, and clip 3.

In step S205, the server performs special effect processing on the initial clipped video according to a special effect type corresponding to each of the target game events to obtain a target clipped video.

In an implementation, the server may determine the special effect type corresponding to each of the target game events. The special effect type may include slow play, a playback, transition, a texture, a sound effect and the like, which is not limited in this disclosure. After determining the special effect type corresponding to each of the target game events, the special effect processing can be performed on the initial clipped video according to the special effect type corresponding to each of the target game events. Specifically, in the initial clipped video, special effect processing corresponding to the special effect type can be added to the game video clip corresponding to each of the target game events, and the initial clipped video after special effect processing is the target clipped video.

In step S206, the server transmits the target clipped video to the client.

In step S207, the client obtains the target clipped video, displays a clipped video playback interface when a playback operation for the target clipped video is detected, and plays the target clipped video on the clipped video playback interface.

In an implementation, after the client receives the target clipped video transmitted by the server, and when a playback operation for the target clipped video is detected, a clipped video playback interface can be displayed, and the target clipped video can be played on the clipped video playback interface. The user can watch the highlight clips generated by the user when he executes the game on the video clipped video playback interface.

In an embodiment of this disclosure, the client may display a game settlement interface, and when the video clipping control included in the game settlement interface is triggered, the client may transmit a video clipping request to the server. The server may, in response to the video clipping request, obtain a to-be-processed game video and game event data corresponding to the to-be-processed game video, and determine clipping reference information according to the game event data. Then the server can perform video clipping processing on the to-be-processed game video according to the clipping reference information to obtain an initial clipped video, and determine a special effect type corresponding to each of the target game events, so as to perform special effect processing on the initial clipped video according to the special effect type corresponding to each of the target game events to obtain a target clipped video. Further, the server may transmit the target clipped video to the client. Then after the client obtains the target clipped video, and when a playback operation for the target clipped video is detected, a clipped video playback interface can be displayed, and the target clipped video can be played on the clipped video playback interface. By implementing the foregoing method, game data of a game match can be analyzed and a more accurate judgment of highlight moments can be realized, and special effect processing can also be performed on a clipped game video to automatically generate a game highlight video about a game player, to improve the efficiency of generating the game clipped video.

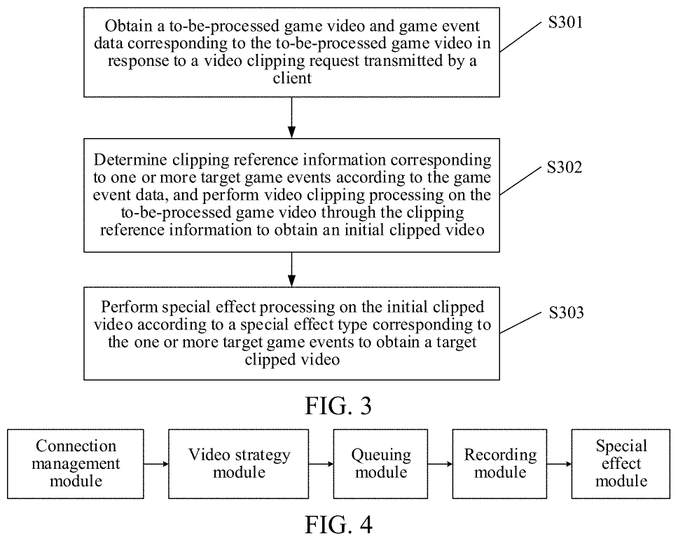

FIG. 3 is a schematic flowchart of a video clipping method according to an embodiment of this disclosure. This embodiment mainly describes a specific implementation process in which the server determines the target clipped video. The video clipping method described in this embodiment includes the following steps:

In step S301, a to-be-processed game video and game event data corresponding to the to-be-processed game video are obtained in response to a video clipping request transmitted by a client. In an example, a game video and game event data corresponding to the game video are obtained in response to receiving a video clipping request.

In an implementation, the server may receive a video clipping request from the client. After the server receives the video clipping request, a to-be-processed game video and game event data corresponding to the to-be-processed game video may be obtained, so as to process the to-be-processed game video according to the game event data to obtain a target clipped video. The to-be-processed game video may be a game match video that a user ends at any time, and the game event data corresponding to the to-be-processed game video may be behavior data in the game when the user executes the game.

In an implementation, the server may receive video clipping requests transmitted by a plurality of clients. When the server receives the video clipping requests transmitted by the plurality of clients within a same time period, the video clipping requests of each client can be responded to according to feature information of each client. In a specific implementation, the feature information of each client can be determined. The feature information may include one or more of user features and game features. For example, the user feature may refer to a historical duration of the user using the client, and a user whose historical duration of using the client exceeds a preset duration is defined as an old user. Correspondingly, a user whose historical duration of using the client does not exceed the preset duration is defined as a new user. In another example, the user feature may also refer to a user level of the user, and the user level may be A level, B level, C level, and the like. The game feature may refer to various highlight performance in the to-be-processed game video, for example, the highlight performance may be “three consecutive eliminations”, “dive into tower and defeat”, “skill control” and the like. After the feature information of each client is determined, a priority relationship among the plurality of clients may be determined according to the feature information of each client. Corresponding priorities can be preset for each user feature and each game feature. For example, different user features have different first priorities, and different game features may also have different second priorities. When the feature information includes the user feature, the priority relationship among the plurality of clients may be determined according to the first priority corresponding to the user feature of each client, where the priority of each client may be the first priority corresponding to the user feature; when the feature information includes the game feature, the priority relationship among the plurality of clients may be determined according to the second priority corresponding to the game feature of each client, where the priority of each client may be the second priority corresponding to the game feature; and when the feature information includes the user feature and the game feature, the priority relationship among the plurality of clients may be determined according to the first priority corresponding to the user feature of each client and the second priority corresponding to the game feature, where the priority of each client may be a sum of the first priority corresponding to the user feature and the second priority corresponding to the game feature, or may be other relationships between the first priority and the second priority, which is not limited in this disclosure. Then, after the priority relationship among the plurality of clients is determined, the video clipping requests of the plurality of clients can be sequentially responded to according to priorities indicated by the priority relationship in descending order.

For example, a mapping relationship between the user feature and the first priority is shown in Table 1. Suppose the feature information includes the user feature, and the server receives video clipping requests transmitted by three clients (client 1, client 2, client 3). User features corresponding to the three clients are user feature B, user feature A, and user feature C. According to the mapping relationship between the user feature and the first priority shown in Table 1, a first priority of client 1 is 5, a first priority of client 2 is 7, and a first priority of client 3 is 3, and then a priority relationship of the three clients is client 2>client 1>client 3. Then, according to priorities indicated by the priority relationship, the order from high to low is client 2, client 1, client 3, that is, the video clipping requests of the three clients are sequentially responded to in an order of client 2, client 1, and client 3.

In another example, a mapping relationship between the game feature and the second priority is shown in Table 2. Suppose the feature information includes the game feature, and the server receives video clipping requests transmitted by three clients (client 1, client 2, client 3). Game features corresponding to the three clients are game feature B, game feature A, and game feature C. According to the mapping relationship between the game feature and the second priority shown in Table 2, a second priority of client 1 is 3, a second priority of client 2 is 5, and a second priority of client 3 is 7, and then a priority relationship of the three clients is client 3>client 2>client 1. Then, according to priorities indicated by the priority relationship, an order from high to low is client 3, client 2, client 1, that is, the video clipping requests of the three clients are sequentially responded to in an order of client 3, client 2, and client 1.

In another example, supposing that the feature information includes the user feature and the game feature, and the server receives video clipping requests transmitted by three clients (client 1, client 2, and client 3), a user feature corresponding to client 1 is the user feature B, and a game feature is the game feature C; a user feature corresponding to client 2 is the user feature A, and a game feature is the game feature B; and a user feature corresponding to client 3 is the user feature C, and a game feature is the game feature A. Taking a priority of each client as a sum of the first priority corresponding to the user feature and the second priority corresponding to the game feature as an example, it can be seen from Table 1 and Table 2 that, a priority of client 1 is 8 (5+3), a priority of client 2 is 12 (7+5), and a priority of client 3 is 10 (3+7), then a priority relationship of the three clients is client 2>client 3>client 1. Then, according to priorities indicated by the priority relationship, an order from high to low is client 2, client 3, and client 1, that is, the video clipping requests of the three clients are sequentially responded to in an order of client 2, client 3, and client 1.

In some embodiments, the first priority and the second priority can be represented by numbers “1-9” to indicate the level of the priority. From “9” to “1”, the priority is lowered by one level, and the number “9” indicates the highest priority. In another embodiment, the priority may also be represented by letters or characters, and this embodiment of this disclosure does not specifically limit the representation manner of the priority.

TABLE 1

| User feature | First priority |
|---|---|
| User feature A | 7 |
| User feature B | 5 |
| User feature C | 3 |

TABLE 2

| Game feature | Second priority |
|---|---|
| Game feature A | 7 |
| Game feature B | 5 |
| Game feature C | 3 |

In step S302, clipping reference information corresponding to one or more target game events is determined according to the game event data, and video clipping processing is performed on the to-be-processed game video through the clipping reference information to obtain an initial clipped video. In an example, clipping reference information corresponding to one or more target game events in the game video is determined according to the game event data. In an example, an initial clipped video is generated. The initial clipped video includes at least one video clip from the game video based on the clipping reference information.

In an implementation, a plurality of reference game events and a mapping relationship between reference game events and reference special effect types may be pre-configured. The foregoing configuration may exist in the form of a list and be stored in a designated area, where the designated area may be set according to requirements, which is not limited in this disclosure. For example, the pre-configured game event list may be as shown in Table 3. The game event list includes a plurality of reference game events and a mapping relationship between the reference game events and the reference special effect types. It can be seen from Table 3 that the reference game event may include a game event A, a game event B, a game event C and the like. A reference special effect type corresponding to the game event A is a special effect type E and a reference special effect type corresponding to the game event B is a special effect type F.

TABLE 3

| Reference game event | Reference special effect type |
|---|---|
| Game event A | Special effect type E |
| Game event B | Special effect type F |
| Game event C | Special effect type G |
| . . . | . . . |

In an implementation, a specific implementation of determining clipping reference information corresponding to one or more target game events according to the game event data may be: first obtaining a pre-configured game event list, and after obtaining the game event list, one or more target game events and clipping time information corresponding to each of the target game events may be determined from the game event data according to the game event list. Specifically, the game event data may be matched with a plurality of reference game events included in the game event list, and the matched reference game event may be determined as a target game event, then one or more target game events may be determined. After the target game event is determined, clipping time information corresponding to each of the target game events can be determined from the game event data. Then clipping reference information corresponding to the one or more target game events can be determined according to the clipping time information corresponding to each of the target game events. That is, for any target game event, the clipping time information corresponding to the target game event may be included in the clipping reference information corresponding to the target game event. The clipping time information may be a clipping start time and a clipping end time when the target game event is clipped.

For an exemplary implementation of performing video clipping processing on the to-be-processed game video by using the clipping reference information to obtain the initial clipped video in S302, reference may be made to relevant specific description in the foregoing embodiment S204, which will not be repeated here.

In step S303, special effect processing is performed on the initial clipped video according to a special effect type corresponding to the one or more target game events to obtain a target clipped video. In an example, a target clipped video is generated based on the initial clipped video and a special effect type that is determined to correspond to each of at least one target game event of the one or more target game events.

In an implementation, as can be seen from the above, the game event list not only includes the reference game event, but also includes a mapping relationship between the reference game events and the reference special effect types. For example, as shown in Table 3, a reference special effect type corresponding to the game event A is a special effect type E, a reference special effect type corresponding to the game event B is a special effect type F and the like. Then, the game event list can be obtained, and the special effect type corresponding to each of the target game events can be determined according to a mapping relationship between reference game events and reference special effect types included in the game event list. The reference special effect type may include slow play of the video, a playback of the video, transition of the video, adding a texture to the video, adding a sound effect to the video and the like, and may also include other reference special effect types, which are not limited in this disclosure. After determining a special effect type corresponding to each of the target game events, special effect processing can be performed on the initial clipped video according to the special effect type corresponding to each of the target game events to obtain a target clipped video. Specifically, special effect adding time information corresponding to each of the target game events can be determined. The special effect adding time information may refer to a moment when the special effect type is to be added in the game video clip corresponding to each of the target game events, and the special effect adding time information may be obtained from the game event data. For example, for a certain target game event, there may be a highlight moment in the target game event (it can be understood as a moment when a certain high-end operation is used in the target game event), then, the highlight moment can be used as a moment to add the special effect type. In another example, a clipping start time of the target game event can also be used as a moment to add the special effect type. The moment of adding the special effect type may also be defined by other standards, which is not limited in this disclosure. Then, after determining the special effect adding time information corresponding to each of the target game events, special effect processing can be performed on the initial clipped video according to the special effect type and the special effect adding time information corresponding to each of the target game events to obtain a target clipped video. It can be seen that by adding the special effect to the initial clipped video, content of the target clipped video obtained by the user can be more colorful, thereby improving the user experience.

In an implementation, after an initial clipped video is determined, special effect processing can be performed on the initial clipped video on a server side to obtain a target clipped video, or special effect processing can be performed on the initial clipped video on a client side to obtain a target clipped video. A specific implementation of performing special effect processing on an initial clipped video on a client side to obtain a target clipped video may be after a server side obtains an initial clipped video, the initial clipped video is transmitted to the client. Then after the client receives the initial clipped video, a special effect type corresponding to each of the target game events may be determined. The manner of determining the special effect type corresponding to each of the target game events may be similar to the foregoing manner in which the server side determines the special effect type corresponding to each of the target game events. That is, a mapping relationship between a plurality of reference game events and special effect types may be preset, so as to determine the special effect type corresponding to each of the target game events according to the mapping relationship. After determining a special effect type, special effect processing can be performed on the initial clipped video according to the special effect type corresponding to each of the target game events to obtain a target clipped video. In an actual production environment, there is a cost requirement to implement special effect processing for the initial clipped video on the server side, but it can be completed before the user browses the video. On the client side, there is no cost requirement to implement special effect processing for the initial clipped video, but the user is required to wait online for the synthesis of the target clipped video. Therefore, it can be determined according to business requirements whether to implement special effect processing on the initial clipped video on the server side, or to implement special effect processing on the initial clipped video on the client side, which is not limited in this disclosure.

In the embodiments of this disclosure, a server may respond to a video clipping request transmitted by a client to obtain a to-be-processed game video and game event data corresponding to the to-be-processed game video, and determine clipping reference information according to the game event data, and then perform video clipping processing on the to-be-processed game video according to the clipping reference information to obtain an initial clipped video. After determining a special effect type corresponding to each of the target game events, special effect processing can be performed on the initial clipped video according to the special effect type corresponding to each of the target game events to obtain a target clipped video. By implementing the foregoing method, game data of a game match can be analyzed and an accurate judgment of highlight moments can be realized, and special effect processing can also be performed on a clipped game video to automatically generate a game highlight video about a game player, effectively improving the efficiency of generating the game clipped video. It can also realize automatic filming of game highlight clips, special effects and the like of a plurality of game players, and can support the generation of a highlight video of a historical game match within a certain period of time. In addition, it can get rid of dependence on the performance of a game client, and can use the server to realize the generation and storage of a game clipped video, so as to reduce memory occupation of the client.

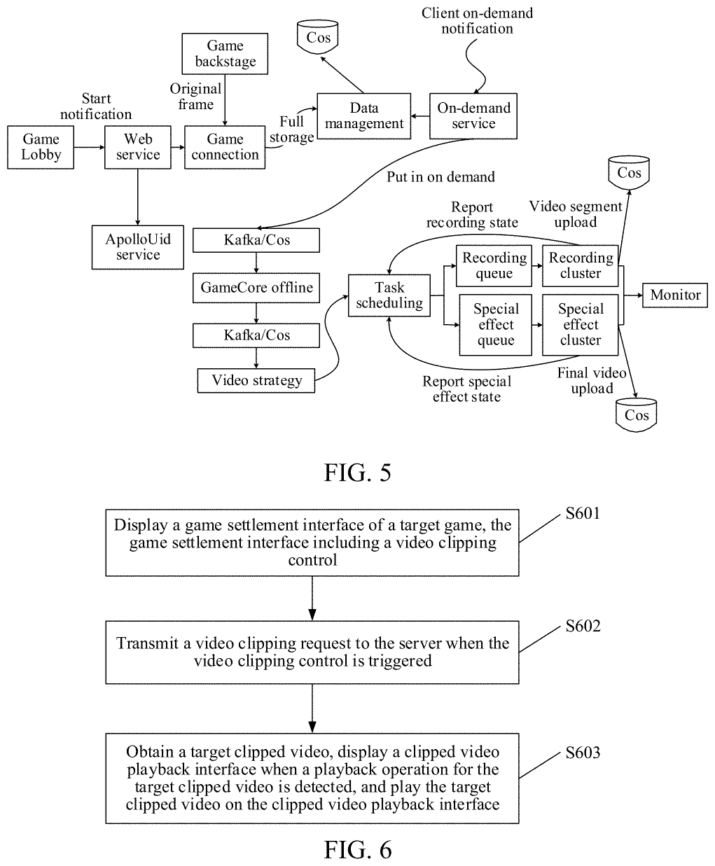

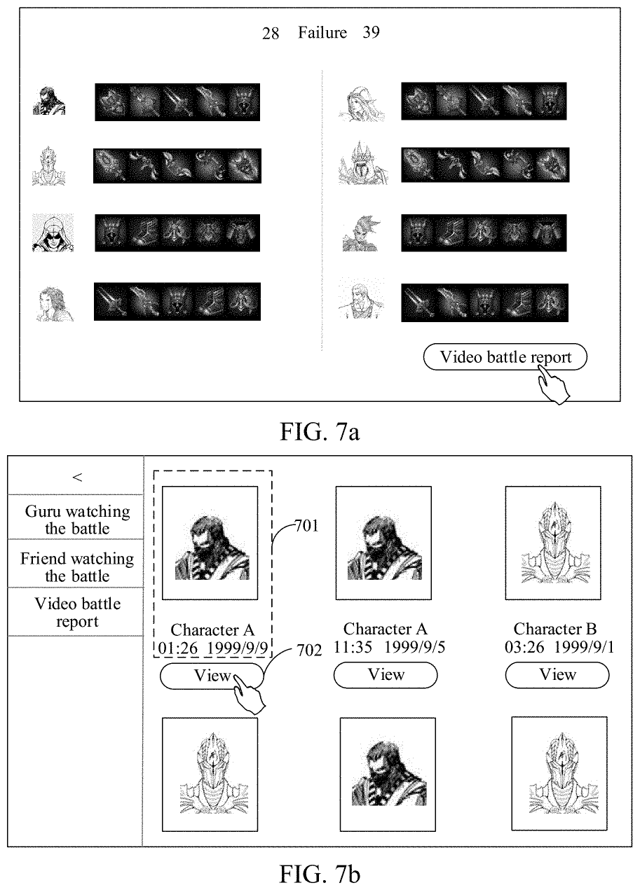

To better understand the video clipping method provided in the embodiments of this disclosure, further description is given below with reference to the flow shown in FIG. 4. As shown in FIG. 4, the video clipping method in this disclosure may include five modules. One or more modules can be implemented by processing circuitry, software or a combination thereof, for example. The five modules are a connection management module, a video strategy module, a queuing module, a recording module and a special effect module. For exemplary implementations of the five modules, reference may be made to the schematic flowchart of the video clipping method shown in FIG. 5. It can be seen from FIG. 5 that the connection management module only needs to process game data. The game data includes the foregoing to-be-processed game video and game event data. Specifically, a game lobby of the client can receive a game start notification transmitted by one or more users through the client. Then, the client can connect to the Web service and the ApolloUid service to realize a connection to the game, and then the user can start to execute the game process. Relevant data obtained when the user executes the game can be obtained from a game backstage. The relevant data may be, for example, data corresponding to a game item required by the user during the game, data corresponding to an eliminated opponent and the like. The obtained relevant data may be original frame data. In addition, data management can be performed on the game event data generated during the game, and the game event data can be stored in a specified manner, for example, the game event data can be stored in a cloud object storage (Cos). When receiving an on-demand notification transmitted by the client (the on-demand notification can be understood as the foregoing video clipping request), a to-be-processed game video and game event data requested for the on-demand notification can be obtained from a designated area through an on-demand service. The to-be-processed game video and the game event data can be stored in the designated area. The designated area may be the storage area described above that is stored in a designated manner, or may be other storage areas. For example, under the Linux system, Kafka (Kafka is a distributed message system) can be used as a designated area, that is, the game event data corresponding to the to-be-processed game video is stored in Kafka. The game event data may be original frame data or state data after processing the original frame data. If the game event data is original frame data, the original frame data can be converted into processed state data in an offline manner through GameCore. In an actual scenario, it can be determined according to business requirements whether the game event data is original frame data or state data after processing the original frame data. In an example, when the user executes the game, the game event data can also be synchronized to Kafka, so that the data in Kafka can be obtained and expanded at any time according to the requirements.

In an implementation, the video strategy module mainly analyzes game event data corresponding to each to-be-processed game video to determine clipping reference information corresponding to the to-be-processed game video. In a specific implementation, the clipping reference information corresponding to the to-be-processed game video can be obtained by directly writing a script code, or the clipping reference information corresponding to the to-be-processed game video can be obtained by converting the script code into a front-end page. A specific manner may be determined by a specific development of the business, which is not limited in this disclosure. For example, taking the front-end page as an example, a plurality of reference game events can be configured on the content management system (CMS) page. Then, based on the configuration, game event data is analyzed and processed to identify target game events included in the game event data and clipping reference information corresponding to each of the target game events. The clipping reference information may include clipping time information and the clipping time information may be a clipping start time of a game video clip corresponding to each of the target game events. The clipping start time and the clipping reference information may also include key anchor points in each of the target game events (it can be understood as the foregoing special effect adding time information), and high-end operations used in the target game event, and the like. After the clipping reference information is obtained, the clipping reference information can be recorded and stored for use in subsequent video clipping processing and special effect processing.

In an implementation, the queue module mainly responds rationally to video clipping requests transmitted by a plurality of clients. Specifically, a priority queue can be used to distribute and process tasks. The video clipping requests transmitted by the plurality of clients can be responded to according to the priority relationship among the plurality of clients. The priority can be determined according to user features and game features, and users are processed in layers according to the priority. Video clipping requests transmitted by high-priority users are prioritized, while video clipping requests transmitted by low-priority users can be delayed or even not processed, which can avoid many unnecessary video clipping tasks without affecting user experience, and can effectively save production costs of the game clipped video.

In an implementation, the recording module mainly performs clipping processing on each to-be-processed game video for the video clipping request to obtain an initial clipped video. Specifically, video clipping processing can be performed on the to-be to-be-processed game video according to clipping time information corresponding to each of the target game events in the to-be-processed game video, so as to obtain an initial clipped video. When clipping processing needs to be performed on a plurality of to-be-processed game videos, that is, the clipping processing is performed on the plurality of to-be-processed game videos in the form of a queue, during the clipping processing process, a clipping state can be reported to determine whether the current clipping processing is successful according to the clipping state. If a clipping state of a certain to-be-processed game video is abnormal, the clipping processing can be performed again on the to-be-processed game video. In an example, in the process of clipping the to-be-processed game video, the to-be-processed game video can be replayed in the form of game playback according to a playback tool for the to-be-processed game video to obtain a corresponding game process, so as to obtain an initial clipped video. The operation of replaying the to-be-processed game video can be performed under Windows. With the help of Windows interface components and a graphics card, the video can be played and clipped at the same time. The playback tool can clip the to-be-processed game video according to the clipping time information corresponding to each of the target game events. In unnecessary game time, the Seek method (the Seek method can be understood as moving a file reading pointer to a designated position) can be used to skip to save clipping time. For example, a 20-minute to-be-processed game video only needs to be clipped for 2-3 minutes.

In the process of performing video clipping on the to-be-processed game video, the to-be-processed game video can be played back according to the designated playback tool to realize the video clipping. In the process of video clipping, considering that when using the playback tool to play the to-be-processed game video, application resources in the playback tool need to be loaded, and loading time of the to-be-processed game video may be a long time, such as more than 30 seconds, so a memory disk storage method instead of a traditional disk storage method is considered to be used, which can speed up a loading rate of the program in the playback tool. In addition, considering that the video generated during the video clipping process are ultimately stored in a cloud server, the video generated during the video clipping process being stored in a memory disk can also greatly improve the clipping efficiency.

In an example, after obtaining the video clipping request transmitted by the client, the server responds to the video clipping request, so as to perform video clipping processing and special effect processing on the to-be-processed game video according to the game event data corresponding to the to-be-processed game video to obtain a target clipped video. It can be understood that the generation of the target clipped video takes a period of time, that is, the user may need to wait for a period of time before the target clipped video can be viewed. Then, it can be considered that in the game process stage when the user executes a certain game, corresponding game event data during the game process is synchronized to a designated area, and the game event data is analyzed to determine a target game event of a game match video (it can be understood as the to-be-processed game video), clipping time information corresponding to each of the target game events and a special effect type corresponding to each of the target game events, and perform video clipping processing and special effect processing on the game match video according to the foregoing determined data. The video clipping of the game match can be realized when the user executes the game process stage of a certain game. Then, when the user requests the target clipped video through the client, waiting time for generating the video can be shortened.

In an implementation, the special effect module mainly performs special effect processing on the initial clipped video to obtain a target clipped video. In a specific implementation, the foregoing initial clipped video can be downloaded locally, that is, the server can transmit the processed clipped video to the client, so as to realize special effect processing on the initial clipped video on the client. Specifically, reference special effect types corresponding to each reference game event may be preset in CMS. After the client obtains the initial clipped video, special effects can be added to the initial clipped video based on the configuration of the CMS and special effect adding time information corresponding to each of the target game events, so as to obtain the target clipped video, making content of the video colorful, funny and beautiful. The special effect processing may be implemented on the client or on the server. When special effect processing needs to be performed on a plurality of to-be-processed game videos, that is, the special effect processing is performed on the initial clipped video in the form of a queue, during the special effect processing process, a special effect state can be reported to determine whether the current special effect processing is successful according to the special effect state. If a special effect state of a certain initial clipped video is abnormal, the special effect processing can be performed again on the initial clipped video.

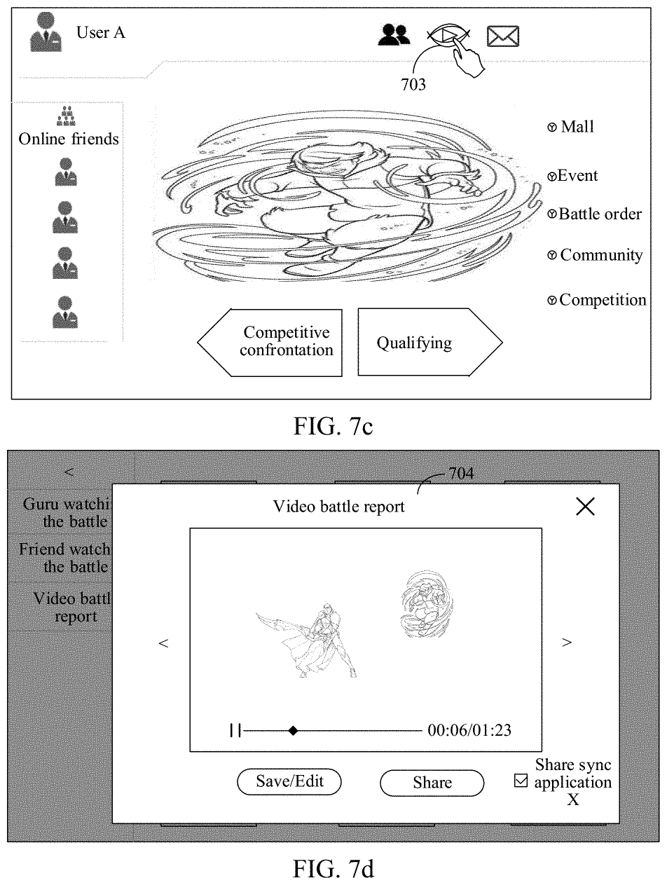

FIG. 6 is a schematic flowchart of a video clipping method according to an embodiment of this disclosure. This embodiment mainly describes a process of displaying the target clipped video on the clipped video playback interface of the client. The video clipping method described in this embodiment includes the following steps:

In step S601, a game settlement interface of a target game is displayed, the game settlement interface including a video clipping control.

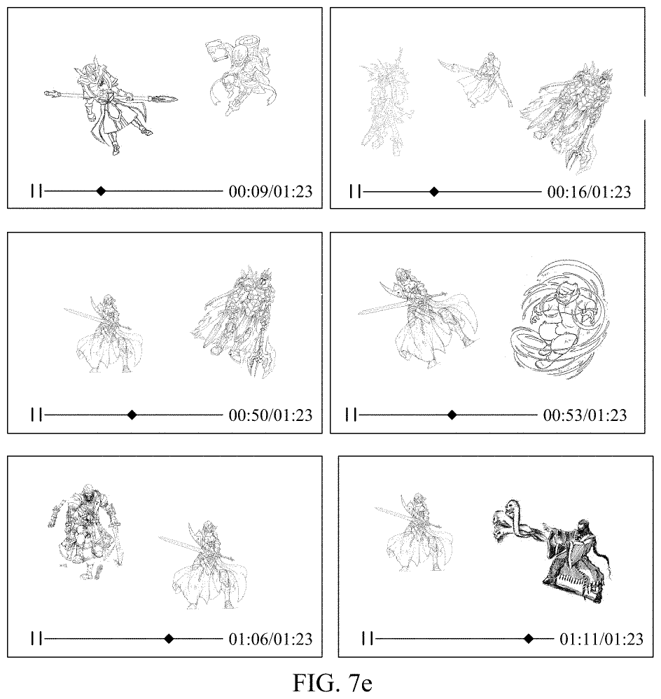

In an implementation, a game settlement interface may be displayed on a client interface, and when a user needs to watch a highlight clip generated during the game, the highlight clip may be understood as the target clipped video in an embodiment of this disclosure. The user can perform a corresponding operation on the game settlement interface, so that the highlight clip can be played on the clipped video playback interface of the client. Specifically, the game settlement interface may include a video clipping control. For example, FIG. 7a is a schematic diagram of a game settlement interface. The video clipping control may be “Video battle report” as shown in FIG. 7a. The user may click the “Video battle report”, so as to trigger a video clipping request to obtain a target clipped video.

In step S602, a video clipping request is transmitted to the server when the video clipping control is triggered. In an example, a video clipping request is sent to a server in response to a user operation.

In an implementation, when the video clipping control is detected, for example, when the user clicks the “Video battle report” as shown in FIG. 7a, the client can transmit a video clipping request to the server. The video clipping request can be configured to request the server to perform video clipping processing and special effect processing on a to-be-processed game video according to game event data corresponding to the to-be-processed game video of the target game to obtain a target clipped video. After the server obtains the target clipped video, the target clipped video can be transmitted to the client. Then the client can receive the target clipped video transmitted by the server, so as to subsequently play the target clipped video on a clipped video playback interface.

In step S603, a target clipped video is obtained, a clipped video playback interface is displayed when a playback operation for the target clipped video is detected, and the target clipped video is played back on the clipped video playback interface. In an example, the target clipped video is generated based on an initial clipped video and a special effect type that is determined to correspond to each of at least one target game event in a game video. The initial clipped video includes a video clip of each of the at least one target game event from the game video.

In an implementation, after the client obtains the target clipped video, the user can view the target clipped video on the clipped video viewing interface. The clipped video viewing interface can display the target clipped video required by the user at the current time, and can also display the historical clipped video required by the user at the historical time. The clipped video viewing interface may include identification information of the target clipped video and a video playback control associated with the target clipped video. For example, FIG. 7b is a schematic diagram of a game video viewing interface. The identification information may be basic video information about the target clipped video. For example, the identification information may include a game character used by the user during the game, time of obtaining the target clipped video, playback duration of the target clipped video and the like, which is not limited in this disclosure. For example, an area marked by 701 in FIG. 7b displays the identification information for the target clipped video. The identification information is that the game character used by the user during the game is “character A”. The time of obtaining the target clipped video is Sep. 9, 1999, and the playback duration of the target clipped video is 1 minute and 26 seconds. The video playback control associated with the target clipped video may be a control marked by 702 in FIG. 7b. The user may click the control to realize the subsequent playback of the target clipped video.

In an implementation, the client may display a game video center interface before displaying the game video viewing interface. The game video center interface includes a game video control. For example, FIG. 7c is a schematic diagram of a game video central interface. The game video control may be a control marked by 703 in FIG. 7c. When the user clicks the control, the client can jump from the game video center interface to the game video viewing interface.

In an implementation, when the video playback control is triggered, it can be determined that a playback operation for the target clipped video is detected, then a clipped video playback interface can be displayed and the target clipped video can be played on the clipped video playback interface. For example, when the user clicks the control marked by 702 in FIG. 7b, the client can display the clipped video playback interface and play the target clipped video on the clipped video playback interface. The clipped video playback interface can exist in the form of a pop-up window, or can exist in the form of an interface of the client. For example, taking the example that the clipped video playback interface exists in the form of a pop-up window, when the user clicks the control marked by 702 in FIG. 7b, the clipped video playback interface can be displayed on the game video viewing interface. The clipped video playback interface may be an interface marked by 704 in FIG. 7d. When the clipped video playback interface is displayed, the interface is in a state of playing the target clipped video, and six interfaces shown in FIG. 7e are playback screens corresponding to the target clipped video at six moments respectively.

In an implementation, an operation control for a corresponding function may also be provided on the clipped video playback interface. Then the clipped video playback interface may further include at least one operation control. For example, the operation control included in the clipped video playback interface may be a video save control, a video sharing control, and a video editing control. When different operation controls are triggered, the clipped video playback interface may also change accordingly.

In an example, when the video save control in the clipped video playback interface is triggered, a target clipped video can be saved. The target clipped video can be saved in a game client, or in other applications, for example, an application configured to provide the user with sharing or watching videos.

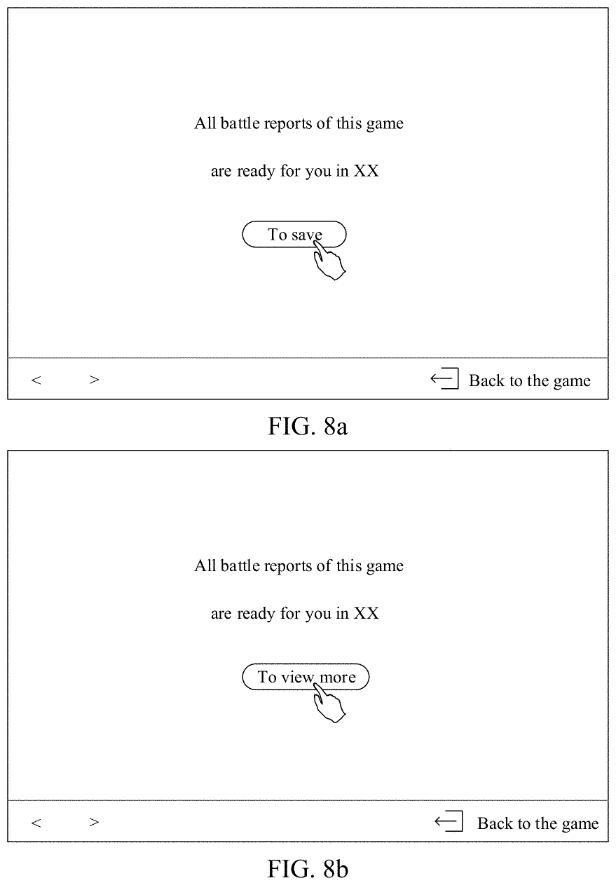

For example, the video save control may be “Save” as shown in FIG. 7d. If the user clicks “Save”, the client can jump from the interface marked by 704 in FIG. 7d to a saving target clipped video interface as shown in FIG. 8a. The interface shown in FIG. 8a includes a save control, and the save control may be “To Save” as shown in FIG. 8a. When the user clicks “To Save”, the client can jump to other applications, so that the target clipped video can be saved in other applications, and then the target clipped video can be viewed in a plurality of storage areas in the future, to improve the user experience.

In an example, when the video sharing control in the clipped video playback interface is triggered, the target clipped video can be shared. For example, the target clipped video can be shared to other applications. The video sharing control can be “Share” as shown in FIG. 7d. If the user wants to share the target clipped video to other applications, he can click “Share” as shown in FIG. 7d. If the user needs to share the target clipped video to a specific application, he can select “Share sync application X” as shown in FIG. 7d, and when sharing the target clipped video to a specific application, the interface shown in FIG. 8b can be displayed. The interface can be configured to prompt the user to share the target clipped video in the specific application, and can also prompt the user to watch more highlight clips for game videos in the specific application. For example, when the user clicks “Watch More” as shown in FIG. 8b, the user can jump to the specific application.

In an example, when the video editing control in the clipped video playback interface is triggered, the video editing interface can be displayed. The video editing interface may include a plurality of special effect operation controls. For example, FIG. 8c to FIG. 8e are video editing interfaces according to an embodiment of this disclosure. As can be seen from FIG. 8c to FIG. 8e, the video editing interface may include a plurality of special effect operation controls, then, the target clipped video can be processed according to the operation of the special effect operation controls to obtain a processed clipped video.

For example, the video editing control can be “Edit” shown in FIG. 7d. If the user clicks “Edit”, the client interface can jump from the interface marked by 704 in FIG. 7d to the interface shown in FIG. 8c to FIG. 8e. The user can change or replace the special effect of the target clipped video, including clipping and splicing clips, changing background music, changing sticker animations, changing frame backgrounds and the like. For example, special effect operation controls such as splitting, changing speed, adjusting speed, and deleting the target clipped video are displayed in FIG. 8c. The user can clip the target clipped video again according to relevant special effect controls in FIG. 8c, and splice the clipped video clips, thereby obtaining a video required by the user. In another example, in FIG. 8d, special effect controls for adjusting a video size are displayed, that is, the target clipped video can be adjusted, for example, the size of the target clipped video can be adjusted to 9:16, 3:4 or the like. A frame background special effect shown in FIG. 8d can also be used to replace a frame background of the target clipped video. For example, the frame background of the target clipped video can be replaced with natural, simple or the like. In another example, a special effect control for replacing background music of the target clipped video is displayed in FIG. 8e. For example, the background music of the target clipped video can be replaced with music 2, music 3, or the like.

In an embodiment of this disclosure, the client may display a game settlement interface, and the game settlement interface includes a video clipping control. When the video clipping control is triggered, a video clipping request is transmitted to the server, and the video clipping request can be configured to request the server to perform video clipping processing and special effect processing on a to-be-processed game video to obtain a target clipped video. Then the client can receive the target clipped video transmitted by the server, and display a clipped video playback interface when a playback operation for the target clipped video is detected, and play the target clipped video on the clipped video playback interface. By implementing the foregoing method, it can be analyzed according to the game match data to achieve an accurate judgment of highlight moments, and a game-specific special effect can be added to achieve one-click filming. In addition, it can also improve perception of the game clipped video such as clarity, frame rate, effect, and support related operations on the game clipped video, such as sharing, secondary editing, thereby effectively improving the user experience.

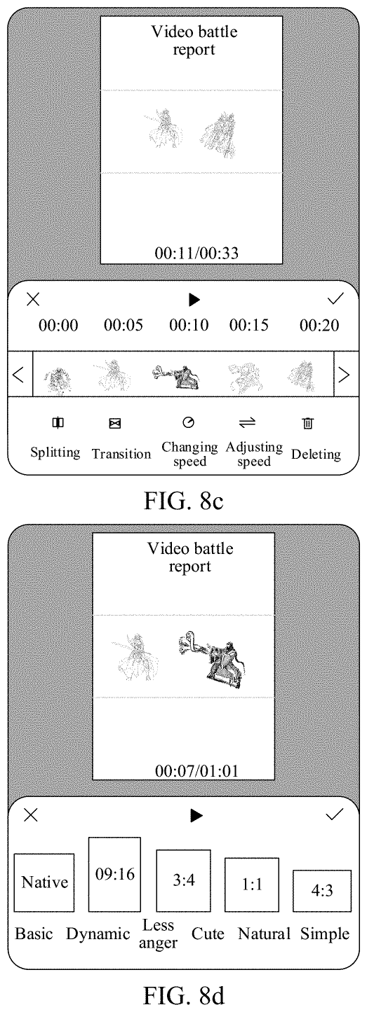

FIG. 9 is a schematic structural diagram of a video clipping apparatus according to an embodiment of this disclosure. The video clipping apparatus may be applicable to the server in the foregoing embodiments. The apparatus includes an obtaining unit 101, a first determining unit 102 and a second determining unit 103. One or more modules, submodules, and/or units of the apparatus can be implemented by processing circuitry, software, or a combination thereof, for example.

The obtaining unit 101 is configured to obtain a to-be-processed game video and game event data corresponding to the to-be-processed game video, in response to a video clipping request transmitted by a client.

The first determining unit 102 is configured to determine clipping reference information corresponding to one or more target game events according to the game event data, and perform video clipping processing on the to-be-processed game video through the clipping reference information to obtain an initial clipped video.

The second determining unit 103 is configured to perform special effect processing on the initial clipped video according to a special effect type corresponding to the one or more target game events to obtain a target clipped video.

In an implementation, the second determining unit 103 is further configured to determine special effect adding time information corresponding to each of the target game events; and perform the special effect processing on the initial clipped video according to a special effect type corresponding to the target game event and the special effect adding time information to obtain the target clipped video.

In an implementation, the first determining unit 102 is further configured to: obtain a stored game event list; determine the one or more target game events from the game event data according to reference game events included in the game event list; and determine clipping time information corresponding to the target game events according to the game event data, and determine the clipping reference information corresponding to the target game events according to the clipping time information.

In an implementation, the game event list further includes a mapping relationship between reference game events and reference special effect types, and the second determining unit 103 is further configured to determine the special effect type corresponding to the one or more target game events according to the mapping relationship included in the game event list between the reference game events and the reference special effect types included in the game event list.

In an implementation, the apparatus further includes a response unit 104. The response unit 104 is further configured to determine feature information of each client in a case that video clipping requests transmitted by a plurality of clients are received within a same time period, the feature information including at least one of a user feature or a game feature; determine a priority relationship among the plurality of clients according to the feature information of each client; and sequentially respond to the video clipping requests of the plurality of clients according to priorities indicated by the priority relationship in descending order.

In an implementation, the apparatus further includes a transmitting unit 105. The transmitting unit 105 is further configured to transmit the target clipped video to the client, so that in a case of detecting a playback operation for the target clipped video, the client displays a clipped video playback interface, and plays the target clipped video on the clipped video playback interface.

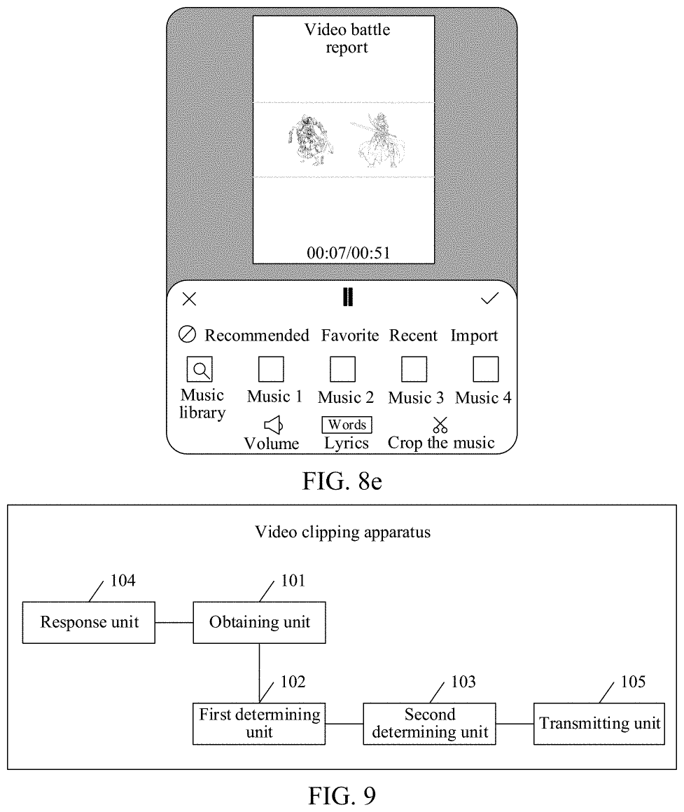

FIG. 10 is a schematic structural diagram of a video clipping apparatus according to an embodiment of this disclosure. The video clipping apparatus may be applicable to the client in the foregoing embodiments, and the apparatus includes: a first display unit 201, a transmitting unit 202, and a second display unit 203. One or more modules, submodules, and/or units of the apparatus can be implemented by processing circuitry, software, or a combination thereof, for example.

The first display unit 201 is configured to display a game settlement interface of a target game, the game settlement interface including a video clipping control.

The transmitting unit 202 is configured to transmit a video clipping request to a server in a case that the video clipping control is triggered, the video clipping request being used for requesting the server to perform video clipping processing and special effect processing on a to-be-processed game video of the target game to obtain a target clipped video.

The second display unit 203 is configured to obtain the target clipped video, display a clipped video playback interface in a case that a playback operation for the target clipped video is detected, and play the target clipped video on the clipped video playback interface.

In an implementation, the apparatus further includes a third display unit 204. The third display unit 204 is further configured to display a clipped video viewing interface, the clipped video viewing interface including identification information of the target clipped video and a video playback control associated with the target clipped video; and determine that the playback operation for the target clipped video is detected in a case that the video playback control is triggered.

In an implementation, the clipped video playback interface further includes a video editing control; and the apparatus further includes an editing unit 205. The editing unit 205 is further configured to display a video editing interface in a case that the video editing control is triggered, the video editing interface including a plurality of special effect operation controls; and process the target clipped video according to an operation for the special effect operation control to obtain a processed clipped video.

It may be understood that in embodiments of this disclosure, the division of the modules is merely an example, and is merely division of logical functions. During actual implementation, there may be another division manner. Functional modules in the embodiments of this disclosure may be integrated into one processing module, or each of the modules may exist alone physically, or two or more modules may be integrated into one module. The integrated module may be implemented in the form of hardware, or may be implemented in a form of a software functional module.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

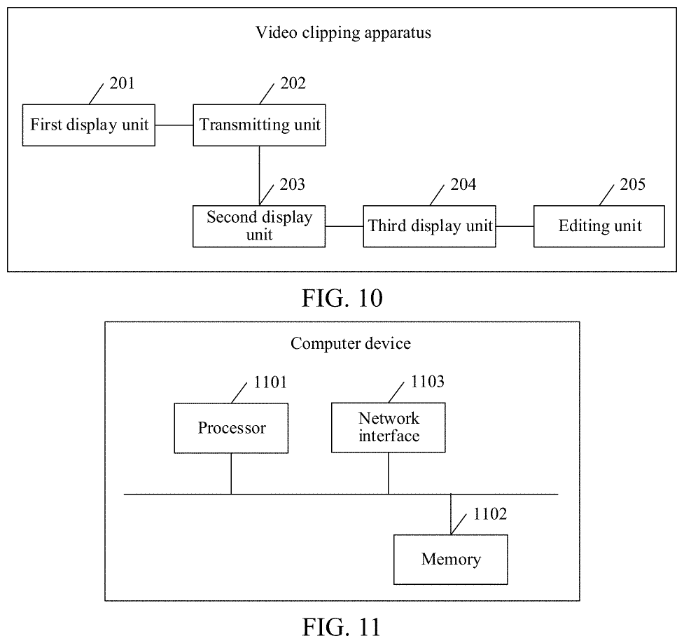

FIG. 11 is a schematic structural diagram of a computer device according to an embodiment of this disclosure. The computer device may be the foregoing server and/or client, or may perform some or all of the steps performed by the foregoing server and/or client. The computer device described in an embodiment includes: a processor 1101, a memory 1102, and a network interface 1103. Data can be exchanged among the foregoing processor 1101, the memory 1102, and the network interface 1103.

The foregoing processor 1101 may be processing circuitry, such as a central processing unit (CPU). The processor may further be another general-purpose processor, a digital signal processor (DSP), an application-specific integrated circuit (ASIC), a field-programmable gate array (FPGA), or another programmable logic device, a discrete gate or a transistor logic device, a discrete hardware component, or the like. The general-purpose processor may be a microprocessor, or the processor may be any conventional processor, or the like.

The foregoing memory 1102 may include a read-only memory (ROM) and a random access memory (RAM), and provide a program instruction and data to the processor 1101. A part of the storage 1102 may further include a non-volatile random access memory.

In some embodiments, the computer device may be a server, or may perform some or all of the steps performed by the server. For example, the processor 1101, when calling the program instruction, is configured to obtain a to-be-processed game video and game event data corresponding to the to-be-processed game video, in response to a video clipping request transmitted by a client; determine clipping reference information corresponding to one or more target game events according to the game event data, and perform video clipping processing on the to-be-processed game video through the clipping reference information to obtain an initial clipped video; and performing special effect processing on the initial clipped video according to a special effect type corresponding to the one or more target game events to obtain a target clipped video.

In some embodiments, the computer device may be a client, or may perform some or all of the steps performed by the client. For example, the processor 1101, when calling the program instruction, is configured to display a game settlement interface of a target game, the game settlement interface including a video clipping control; call the network interface 1103 to transmit a video clipping request to a server in a case that the video clipping control is triggered, the video clipping request being used for requesting the server to perform video clipping processing and special effect processing on a to-be-processed game video of the target game to obtain a target clipped video; and obtain the target clipped video, display a clipped video playback interface in a case that a playback operation for the target clipped video is detected, and play the target clipped video on the clipped video playback interface.

According to an aspect of the embodiments of this disclosure, a computer storage medium (such as a non-transitory computer-readable storage medium) is further provided, storing program instructions, the program instructions, when executed, including some or all of the steps of the video clipping method in the embodiments corresponding to FIG. 2, FIG. 3 or FIG. 6.

According to an aspect of the embodiments of this disclosure, a computer program product including instructions is further provided. When the computer program product runs on a computer, the computer is caused to perform the method provided in the foregoing embodiments.

For ease of description, the foregoing method embodiments are described as a series of action combinations. However, a person skilled in the art should know that this disclosure is not limited to the described order of the actions because some steps may be performed in another order or performed at the same time according to this disclosure. In addition, a person skilled in the art is also to understand that the embodiments described in this specification are all exemplary embodiments, and the involved actions and modules are not necessarily required to this disclosure.

A person of ordinary skill in the art may understand that all or some of the steps of the various methods in the foregoing embodiments may be implemented by a program instructing relevant hardware. The program may be stored in a computer-readable storage medium. The storage medium may include: a flash drive, a Read-Only Memory (ROM), a Random Access Memory (RAM), a magnetic disk, an optical disc, and the like.

According to an aspect of the embodiments of this disclosure, a computer program product or a computer program is further provided, the computer program product or the computer program including computer instructions, the computer instructions being stored in a computer-readable storage medium. A processor of a computer device may read the computer instructions from the computer-readable storage medium. The processor executes the computer instructions, so that the computer device performs some or all of the steps of the various method embodiments described above.

Examples of the video clipping method and apparatus, the computer device and the storage medium provided in embodiments of this disclosure are described above. The principles and implementations of this disclosure are described through specific examples in this specification, and the descriptions of the embodiments are only intended to help understand the methods and core ideas of this disclosure. Meanwhile, a person of ordinary skill in the art may make modifications to the specific implementations and application scopes according to the ideas of this disclosure. The content of the specification should not be construed as a limitation to the scope of this disclosure.

What is claimed is:

1. A video clipping method, comprising:
obtaining a game video and game event data corresponding to the game video, in response to receiving a video clipping request;
determining clipping reference information corresponding to one or more target game events in the game video according to the game event data;
generating an initial clipped video, the initial clipped video including at least one video clip from the game video based on the clipping reference information; and
generating a target clipped video based on the initial clipped video and a special effect type that is determined to correspond to each of at least one target game event of the one or more target game events.

2. The method according to claim 1, wherein the generating the target clipped video comprises:
modifying the video clip of each of the at least one target game event included in the initial clipped video according to the special effect type that is determined to correspond to the respective target game event.

3. The method according to claim 1, wherein the special effect type that is determined to correspond to one of the at least one target game event is one of playback speed, background music, sticker animation, and background image.

4. The method according to claim 1, wherein
the at least one target game event includes a plurality of target game events, and
the generating the target clipped video comprises:
determining special effect adding time information corresponding to each of the plurality of target game events; and
generating the target clipped video based on the initial clipped video, special effect types determined to correspond to the plurality of target game events, and the special effect adding time information.

5. The method according to claim 1, wherein the determining the clipping reference information comprises:
obtaining a stored game event list;
determining the one or more target game events from the game event data according to reference game events included in the game event list;
determining clipping time information corresponding to the target game events according to the game event data; and
determining the clipping reference information corresponding to the target game events according to the clipping time information.

6. The method according to claim 5, wherein the game event list includes a mapping relationship between the reference game events and reference special effect types, and the method further comprises:
determining the special effect type corresponding to each of the at least one target game event according to the mapping relationship included in the game event list between the reference game events and the reference special effect types included in the game event list.

7. The method according to claim 1, further comprising:
determining feature information of each of a plurality of clients when a plurality of video clipping requests are received from the plurality of clients within a same time period, the feature information of each of the plurality of clients including at least one of a user feature or a game feature;
determining a priority relationship among the plurality of clients according to the feature information of each of the plurality of clients; and
responding to the plurality of video clipping requests of the plurality of clients according to priorities indicated by the priority relationship in descending order.

8. The method according to claim 1, further comprising:
sending the target clipped video to a client from which the video clipping request is received.

9. A video clipping method, comprising:
sending a video clipping request to a server, in response to a user operation;
obtaining a target clipped video, the target clipped video being generated based on an initial clipped video and a special effect type that is determined to correspond to each of at least one target game event in a game video, the initial clipped video including a video clip of each of the at least one target game event from the game video; and
playing the target clipped video in response to a playback operation.

10. The method according to claim 9, further comprising:
displaying a clipped video viewing interface, the clipped video viewing interface including identification information of the target clipped video and a video playback control element associated with the target clipped video; and
determining receipt of the playback operation based on a user selection of the video playback control element.

11. The method according to claim 10, wherein the clipped video playback interface further includes a video editing control element, and the method further comprises:
displaying a video editing interface based on a user selection of the video editing control element, the video editing interface including a plurality of special effect control elements that correspond to different special effects; and
generating a processed clipped video based on the target clipped video and a user selection of one of the plurality of special effect control elements.

12. A video clipping apparatus, comprising:
processing circuitry configured to:
obtain a game video and game event data corresponding to the game video, in response to receiving a video clipping request;
determine clipping reference information corresponding to one or more target game events in the game video according to the game event data;
generate an initial clipped video, the initial clipped video including at least one video clip from the game video based on the clipping reference information; and
generate a target clipped video based on the initial clipped video and a special effect type that is determined to correspond to each of at least one target game event of the one or more target game events.

13. The video clipping apparatus according to claim 12, wherein the processing circuitry is configured to:
modify the video clip of each of the at least one target game event included in the initial clipped video according to the special effect type that is determined to correspond to the respective target game event.

14. The video clipping apparatus according to claim 12, wherein
the at least one target game event includes a plurality of target game events, and
the processing circuitry is configured to:
determine special effect adding time information corresponding to each of the plurality of target game events; and
generate the target clipped video based on the initial clipped video, special effect types determined to correspond to the plurality of target game events, and the special effect adding time information.

15. The video clipping apparatus according to claim 12, wherein the processing circuitry is configured to:
obtain a stored game event list;
determine the one or more target game events from the game event data according to reference game events included in the game event list;
determine clipping time information corresponding to the target game events according to the game event data; and
determine the clipping reference information corresponding to the target game events according to the clipping time information.

16. The video clipping apparatus according to claim 15, wherein the game event list includes a mapping relationship between the reference game events and reference special effect types, and the processing circuitry is configured to:
determine the special effect type corresponding to each of the at least one target game event according to the mapping relationship included in the game event list between the reference game events and the reference special effect types included in the game event list.

17. The video clipping apparatus according to claim 12, wherein the processing circuitry is configured to:
determine feature information of each of a plurality of clients when a plurality of video clipping requests are received from the plurality of clients within a same time period, the feature information of each of the plurality of clients including at least one of a user feature or a game feature;
determine a priority relationship among the plurality of clients according to the feature information of each of the plurality of clients; and
respond to the plurality of video clipping requests of the plurality of clients according to priorities indicated by the priority relationship in descending order.

18. The video clipping apparatus according to claim 12, wherein the processing circuitry is configured to:
send the target clipped video to a client from which the video clipping request is received.

19. A non-transitory computer-readable storage medium, storing instructions which when executed by a processor cause the processor to perform the video clipping method according to claim 1.

20. A non-transitory computer-readable storage medium, storing instructions which when executed by a processor cause the processor to perform the video clipping method according to claim 9.
